(19) United States
(12) Patent Application Publication
(10) Pub. No.: US 2015/0123977 A1
(43) Pub. Date: May 7, 2015

(54) LOW LATENCY AND HIGH PERFORMANCE SYNCHRONIZATION MECHANISM AMONGST PIXEL PIPE UNITS

(71) Applicant: Nvidia Corporation, Santa Clara, CA (US)

(72) Inventors: Mrudula KANURI, Hyderabad (IN); Kamal JEET, Bangalore (IN)

(73) Assignee: Nvidia Corporation, Santa Clara, CA (US)

(21) Appl. No.: 14/073,118

(22) Filed: Nov. 6, 2013

(51) Int. Cl. G06T 1/20

(52) U.S. Cl. CPC G06T 1/20; G06T 2210/52
USPC 345/502

(57) ABSTRACT

A method for synchronizing a plurality of pixel processing units is disclosed. The method includes sending a first trigger to a first pixel processing unit to execute a first operation on a portion of a frame of data. The method also includes sending a second trigger to a second pixel processing unit to execute a second operation on the portion of the frame of data when the first operation has completed. The first operation has completed when the first operation reaches a sub-frame boundary.

### TECHNICAL FIELD

The present disclosure relates generally to the field of graphics processor sub-units and more specifically to the field of synchronization among graphics processor sub-units.

### BACKGROUND

In recent years, the capability of graphics processing units (GPUs) has increased from being only single purpose devices used to display frames of video or graphics on a video displays. Today, GPUs may have multiple processors/cores and may be capable of not only graphics processing, but also the ability to perform computations for applications that would previously have been handled by a central processing unit (CPU).

To aid in synchronizing the actions of a CPU and a GPU, synchronization points within software may be used. Synchronization points may be used to ensure that applications running in parallel are synchronized and that those applications waiting for another application to finish are not started early. For example, when multiple applications are running, the applications may be instructed not to proceed beyond a fixed point (or to pause) until all of the applications have reached a selected synchronization point (e.g., a selected event or task being reached or accomplished). Once all the applications have reached the same synchronization point, the applications may then simultaneously proceed.

Synchronization points may also be used in the GPU itself. For example, a synchronization point may be used as a mechanism to synchronize the actions and interactions of modules of a GPU. Each synchronization point may be implemented with a register that monotonically increments each time a pre-defined condition or event occurs. The registers may also wrap around back to zero when a next increment is received at a register that has already reached its maximum value. Therefore, modules will pause their application execution or task execution until each of them has reached a particular numerical position within their respective synchronization point registers.

### SUMMARY OF THE INVENTION

Embodiments of the present invention provide solutions to the challenges inherent in synchronizing modules of a graphics processing unit. In a method according to one embodiment of the present invention, a method for synchronizing a plurality of pixel processing units is disclosed. The method includes sending a first trigger to a first pixel processing unit to execute a first operation on a portion of a frame of data. The method also includes sending a second trigger to a second pixel processing unit to execute a second operation on the portion of the frame of data when the first pixel processing unit has completed the first operation. The first operation has completed when the first operation reaches a sub-frame boundary.

In an apparatus according to one embodiment of the present invention, a graphics processor is disclosed. The graphics processor includes a means for sending a first trigger to a first pixel processing unit to execute a first operation on a portion of a frame of data. The graphics processor also includes a means for sending a second trigger to a second pixel processing unit to execute a second operation on the portion of the frame of data when the first pixel processing unit has completed the first operation. The first operation has completed when the first operation reaches a sub-frame boundary.

In an apparatus according to one embodiment of the present invention, a graphics processor is disclosed. The graphics processor includes a plurality of pixel processing units and a synchronization module coupled to the plurality of pixel processing units. The plurality of pixel processing units are each operable to perform an operation on a portion of a frame of data. The synchronization module is operable to synchronize the plurality of pixel processing units. The synchronization module is further operable to send a first trigger to a first pixel processing unit to execute a first operation on the portion of the frame of data, and to send a second trigger to a second pixel processing unit to execute a second operation on the portion of the frame of data when the first pixel processing unit has completed the first operation. The first operation has completed when the first operation reaches a sub-frame boundary.

### BRIEF DESCRIPTION OF THE DRAWINGS

Embodiments of the present invention will be better understood from the following detailed description, taken in conjunction with the accompanying drawing figures in which like reference characters designate like elements and in which:

FIG. 1 illustrates a block diagram of a computer system that includes a graphics processor according to the prior art;

FIG. 2 illustrates a block diagram of modules of a graphics processor that includes DMA engine for controlling the other modules in accordance with an embodiment of the present invention;

FIG. 3 illustrates an exemplary timeline illustrating the use of synchronization points for synchronizing a pair of operations in accordance with an embodiment of the present invention;

FIG. 4 illustrates an exemplary block diagram of a synchronization module coupled to a plurality of pixel processing units for synchronizing the operations executed by the pixel processing units in accordance with an embodiment of the present invention;

FIG. 5 illustrates an exemplary block diagram of a synchronization module coupled to a plurality of pixel processing units for synchronizing the operations executed by the pixel processing units in accordance with an embodiment of the present invention; and

FIG. 6 illustrates a flow diagram, illustrating the steps to a method for synchronizing a plurality of graphics processors in accordance with an embodiment of the present invention.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation And Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Low Latency and High Performance Synchronization Mechanism Amongst Pixel Pipe Units:

Embodiments of this present invention provide a solution to the increasing challenges inherent in synchronizing the modules of a graphics processing unit (GPU). Various embodiments of the present disclosure provide synchronization of a plurality of modules of a GPU executing operations on a portion of a frame of data stored in a frame buffer in a memory module. The GPU modules (e.g., 2D graphics engine, 3D graphics engine, and other similar modules) may also be known as graphics engines or pixel processing units. In one embodiment, the portion of the frame of data may be defined by specified line resolutions or at macro-block boundaries. As discussed in detail below, synchronization points (also known as “sync points”) established to synchronize the actions of graphics engines/pixel processing units may be set along sub-frame boundaries, rather than full frame boundaries. Such a reduction may reduce latency perceived by the software accessing the GPU, or by an end user. These sync points for synchronizing the processing of a portion of a frame of data, less than a whole frame of data, may also improve the efficiency of the memory storing the frame buffer. The reduced requirements may require less software buffering, more spatial and temporal localities, as well as better usage of system memory resources. As discussed herein, rather than allocating memory sufficient to hold an entire frame of data, only enough memory sufficient to hold the portion of the frame of data need be allocated.

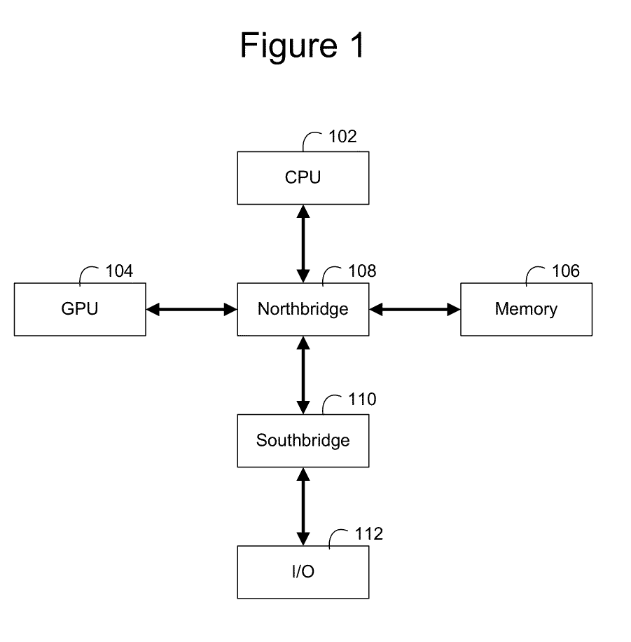

FIG. 1 illustrates an exemplary computer system comprising a central processing unit (CPU) 102 interconnected to a graphics processing unit (GPU) 104, one or more memory modules 106, and a plurality of input/output (I/O) devices 112 through a core logic chipset comprising a northbridge 108 and a southbridge 110. As illustrated in FIG. 1, the northbridge 108 provides a high-speed interconnect between the CPU 102, the GPU 104, and memory modules 106, while the southbridge 110 provides lower speed interconnections to one or more I/O modules 112. In one exemplary embodiment, two or more of the CPU 102, GPU 104, northbridge 108, and southbridge 110 may be combined in an integrated unit.

In one exemplary embodiment, one or more graphics cards 104 may be connected to the northbridge 108 via a high-speed graphics bus (AGP) or a peripheral component interconnect express (PCIe) bus. The one or more memory modules 106 may be connected to the northbridge 108 via a memory bus. The northbridge 108 and the southbridge 110 may be interconnected via an internal bus. Meanwhile, the southbridge 110 may provide interconnections to a variety of I/O modules 112. In one embodiment, the I/O modules 112 may comprise one or more of a PCI bus, serial ports, parallel ports, disc drives, universal serial bus (USB), Ethernet, and peripheral input devices (e.g., keyboard and mouse).

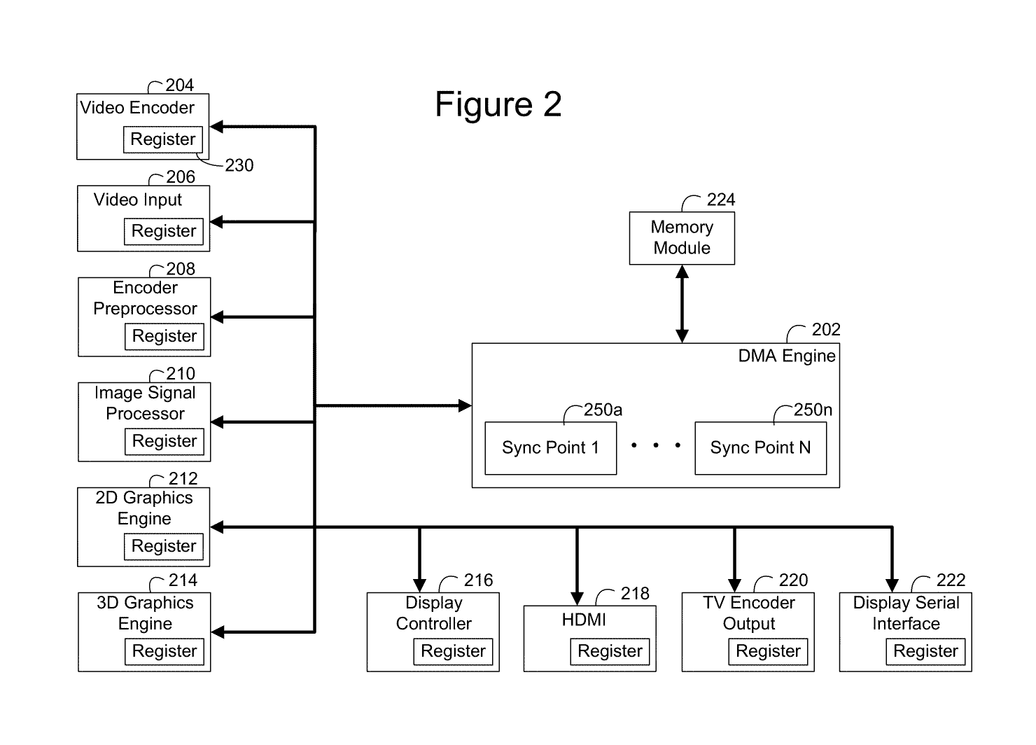

In one embodiment, as illustrated in FIG. 2, an exemplary graphics processing unit (GPU) comprises one or more of the following modules: a video encoder 204, a video input 206, an encoder preprocessor 208, an image signal processor 210, one or more 2D graphics engines 212, one or more 3D graphics engines 214, a display controller 216, an HDMI module 218, a TV encoder output 220, and a display serial interface 222. As also illustrated in FIG. 2, each of the graphics and multimedia related modules contain a number of registers 230 that are used to configure, control and initiate the respective module's functionality. The plurality of modules are addressed and controlled by a DMA engine 202. The modules may also be referred to as clients of the DMA engine 202. As discussed herein, in addition to providing register access (for controlling and configuring module functionality), the DMA engine 202 may also provide synchronization between the modules.

In one embodiment, the DMA engine 202 provides synchronization through the use of sync point registers (250a-250n), which are monotonically incremented counters with wrapping capability. As illustrated in FIG. 2, there may be a plurality of sync point registers (250a-250n). In one embodiment there are 32 sync point registers (250a-250n).

In one embodiment, the sync point registers (250a-250n) may be initialized to a 0 (zero) value at boot-up. The sync point register values (e.g., numerical values) may be programmed, set, or changed by opcodes in a push buffer. For example, the CPU 102 can increment a sync point register (250a-250n) by writing to a particular sync point ID (0-31, for example). The DMA engine 202 may assert an interrupt to the CPU 102 when a selected sync point register value exceeds a selected threshold value. Such an arrangement may allow the CPU 102 to wait until a specific command in a push buffer is executed (a command that results in the sync point register (250a-250n) in question to have incremented to or beyond the specified value. As also discussed herein, the sync point registers (250a-250n) may be incremented by one (1) whenever a pre-defined condition or event occurs. As noted herein, because the sync point registers (250a-250n) have wrapping, when the sync point registers (250a-250n) reach a maximum value, they will wrap back around to zero upon a next increment.

In one exemplary embodiment, for a particular synchronization point, there is a sync point register (250a-250n) for each module that is to be synchronized by the particular synchronization point. When a particular event or condition occurs in one of the modules synchronized by the particular synchronization point, a command is issued from the module to the DMA engine 202 such that the sync point register (250a-250n) assigned to the module for this synchronization point is incremented. In one embodiment, sync point registers (250a-250n) may be incremented in a number of ways: for example, when the CPU 102 writes to a specified sync point register (250a-250n), when a module (204-222) has received a command to increment its sync point register (250a-250n) and a condition specified in the command has come true, or when the DMA engine 202 itself receives a command to increment a specified sync point register (250a-250n).

In one exemplary embodiment, synchronization points may be used at frame boundaries, where interrupts to the CPU may be raised, or as discussed herein, used to synchronized GPU modules (204-222) so that subsequent work waiting for a GPU module (204-222) is received and subsequently acted upon, upon the reaching of the previously established synchronization point value.

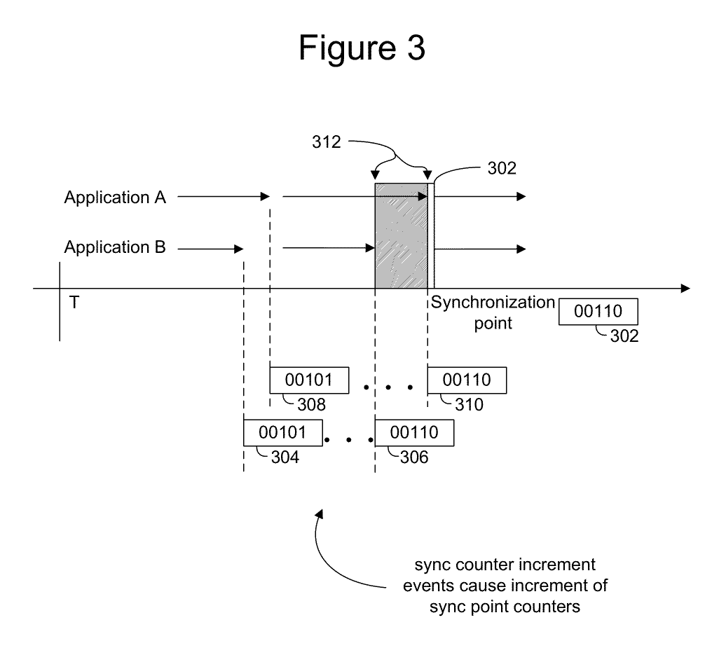

As illustrated in FIG. 3, two applications (Application A and Application B) executed by respective graphics modules, such as graphics engines/pixel processing units in a graphics pipeline of the GPU 104, may be synchronized by respective sync point registers 250a and 250b that are each incrementing (in response to events and/or conditions) towards an exemplary synchronization point value 302 of [00110]. Time is represented along the horizontal.

As illustrated in FIG. 3, Application B continues running (while passing through a sync point register value 304 of [00101]) until its sync point register 250b reaches the selected synchronization point value 302 of [00110]. When a synchronization point value 306 of [00110] is reached by its sync point register 250b, Application B is paused, waiting for Application A to reach the synchronization point value 302 of [00110] as well. As illustrated in FIG. 3, Application A continues running (while passing through a sync point register value 308 of [00101]) until its sync point register 250a reaches the selected synchronization point value 302 of [00110]. When a synchronization point value 310 of [00110] is reached by its sync point register 250a, Application A continues running and Application B is restarted, such that both Application A and Application B restart or continue running simultaneously.

As illustrated in FIG. 3, sync point register 250b increments from a value 304 of [00101] to a value 306 of [00110] which is equal to the synchronization point value 302 of [00110]. As also illustrated in FIG. 3, sync point register 250a increments from a value 308 of [00101] to a value 310 of [00110] which is also equal to the synchronization point value 302 of [00110]. As illustrated in FIG. 3, while the sync point registers 250a and 250b both increment through the same register values, the timing of their increments is different. Lastly, as illustrated in FIG. 3, Application B is paused for a period of time 312 after its sync point register 250b reaches the synchronization point value 302 of [00110], and until sync point register 250a also reaches the synchronization point value 302 of [00110].

In one embodiment, synchronization may be realized using the sync point registers 250a-n. For example, the CPU 102 may be interrupted when a sync point register 250a-n reaches a pre-specified value. In another example, a DMA engine channel (that may be used for sending/receiving data to or from a module of the GPU 202) may have “WAIT” commands so that the channel will wait for a pre-specified synchronization point value reached by one or more sync point registers 250a-n. In one embodiment, an exemplary GPU module (204-222) may be synchronized with a plurality of other GPU modules (204-222) using a plurality of synchronization point values.

### Synchronization Point Behavior of GPU Modules:

In one embodiment, each GPU module (204-222) may be programmed to perform a unit of work or an operation by the DMA engine 202 using code division multiple access (CDMA) (a channel access process) and push buffers. Examples of an exemplary operation include: a large bit copy (BLT) which is used to transfer or display a bitmap; drawing a set of triangles; and encoding a single frame. If nothing else is programmed (the specific push buffer has been emptied), the GPU module (204-222) will go idle until the DMA engine 202 sends additional commands to start another operation (in other words, there is no continuous mode). To do its operation, a GPU module (204-222) reads data from a memory module or memory buffer 224, performs a directed process on the data, and then writes the results into the memory 224. In one exemplary embodiment, the GPU modules (204-222) interact with each other using memory buffers 224 (e.g., one GPU module (204-222) is a producer of data into the memory buffer 224, while another GPU module (204-222) is a consumer of that data in the memory buffer 224).

### Synchronization of Graphics Engines Executing in a Graphics Pipeline:

In one exemplary embodiment, there are two needs for synchronization: management of memory buffers 224 and timing of control register 230 writes. Memory buffers 224 may be used to pass data from one GPU module (204-222) to another GPU module (204-222) using a producer/consumer model. In one embodiment, the memory buffers 224 are circular buffers. As noted herein, the control registers 230 are used to pass commands to the GPU modules (204-222), such that the specified GPU module (204-222) will process the data in the memory buffer 224 according to the command in its control register 230.

To prevent memory buffer 224 overflow and underflow, synchronization needs to be performed in both directions. For example, a consumer module cannot read data from the memory buffer 224 until a producer module is done writing the data to the memory buffer 224. Furthermore, the producer module cannot reuse the memory buffer 224 (e.g., writing to the memory buffer 224) until the consumer module is done reading and processing the data in the memory buffer 224. Therefore, synchronization events required for efficient operation of the memory buffers 224 include: that the consumer module has completed all reads from the memory buffer 224, and that the producer module has completed all writes to the memory module 224.

To understand the requirements for timing the writes to the control registers 230, an exemplary sequence is illustrated below:

1. Register write for operation A.
2. Register write for operation A.
3. Register write (trigger) for operation A.
4. Register write for operation B.
5. Register write for operation B.
6. Register write (trigger) for operation B.
For the above exemplary sequence, if no WAIT command is placed between the trigger for operation A (step 3) and the first register write for operation B (step 4), then in a worst case, corruption of operation A may occur because the original value in the control register 230 is overwritten before operation A is completed. For GPU modules (204-222) that protect against this corruption, there is still the undesirable behavior of the GPU module (204-222) delaying the register write and subsequently causing back pressure on a DMA engine write bus. The WAIT command may be used to provide synchronization. For synchronizing writes to a control register 230, a safe time to start writing to the control register 230 for the next operation (operation B) is defined to be when no corruption will occur for previous operations (e.g., operation A), and that no stalls in a hardware bus will result. Therefore, a synchronization point value that ensures both of these conditions are met may be used.

### Synchronizing Graphics Engines at Frame Boundaries:

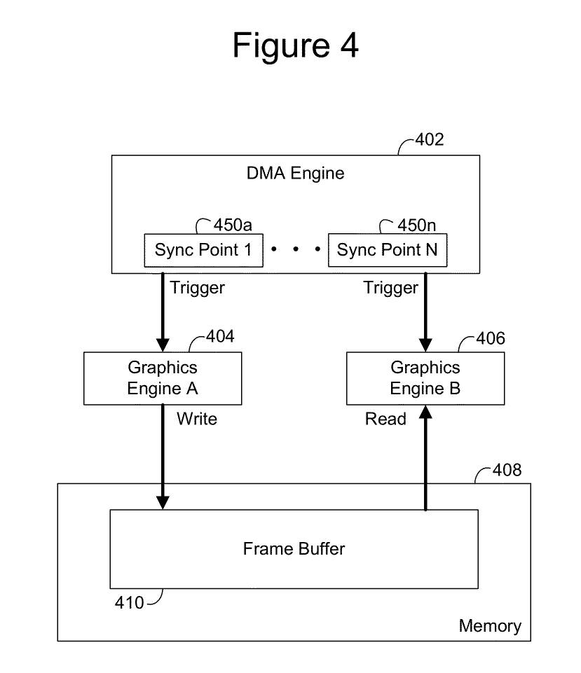

As illustrated in FIG. 4, a plurality of exemplary graphics engines 404, 406 may be used together to process a frame of graphics data in a producer/consumer model. As noted above, an exemplary graphics engine 404, 406 may also be referred to generally as a pixel processing unit. A frame of graphics data comprises the data used to drive a video display, wherein the frame of data may be stored in a frame buffer 410 allocated from a memory module 408. In one embodiment, the data stored in a frame buffer 410 for a frame of data comprises color values, depth and other information for each pixel displayed on the video display.

In one embodiment, the producer graphics engine 404 and the consumer graphics engine 406 both process a frame of data and use a common memory location 408 to exchange data/information between them. Each graphics engine 404, 406 will complete its operation(s) on an entire frame of data (whether preparing a frame of data or processing a frame of data previously stored in the frame buffer 410), such a frame completion may be referred to as a frame boundary. In one exemplary embodiment, the memory 408 may store raw data input from the producer graphics engine 404 and store a processed output frame from the consumer graphics engine 406.

For example, while one graphics engine (e.g., the producer graphics engine 404) is used to prepare and store a frame of data into the frame buffer 410, the second graphics engine (e.g., the consumer graphics engine 406) will subsequently process the frame of data previously stored in the frame buffer 410. After the consumer graphics engine 406 has finished processing the frame of data in the frame buffer 410 (and a processed output frame has been output from the frame buffer 410), the producer graphics engine 404 is free to prepare and store a new frame of data into the frame buffer 410.

As discussed herein, synchronization points may be used to indicate completion of a frame of data (e.g., that the producer graphics engine 404 has completed the preparation and loading of a frame of data into the frame buffer 410, or that the consumer graphics engine 406 has completed the processing and preparation of an output frame of data in the frame buffer 410 for output). As discussed herein, the synchronization points may be implemented as registers or counters whose values may be used to indicate the completion of an event (e.g., input frame of data now ready for consumer graphics engine 406).

However, there may be drawbacks to using a frame boundary for synchronization. Using a frame boundary for synchronization may cause an increased graphics engine startup latency. For example, a consumer graphics engine 406 has to wait for the complete processing of a frame of data by a producer graphics engine 404. Use of a frame boundary as a synchronization point may also result in less spatial and temporal locality which will affect the memory 408 performance. Lastly, synchronizing along a frame boundary requires sufficient software buffering for the full frame of data, which adds to the memory cost.

### Synchronizing Graphics Engines at Sub-Frame Boundaries:

In one exemplary embodiment, a synchronization point may be a sub-portion of a frame of data. For example, a sub-frame of a frame of data may be defined with a configurable line resolution of a full video frame. In another example, a sub-frame of a frame of data may be defined with macro blocks, as a macro-block boundary.

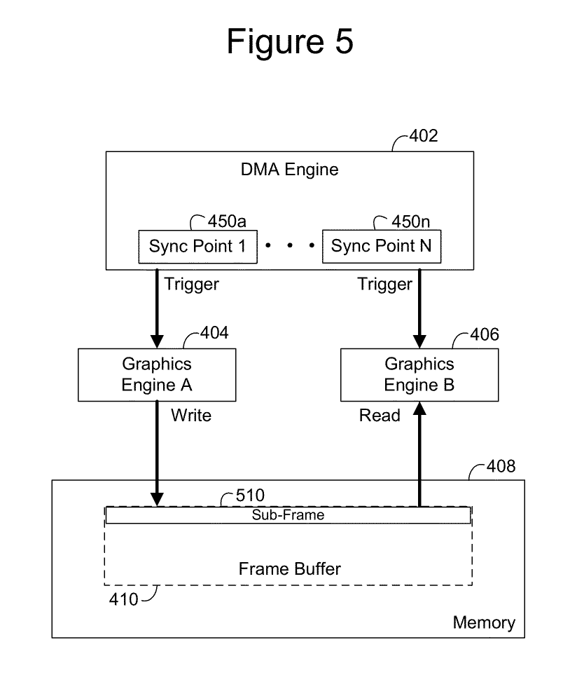

As illustrated in FIG. 5, the memory location reserved and allocated in the memory 408 will be for a sub-frame 510 and not for a complete frame of data. In one embodiment, an amount of memory allocated from the memory module 408 for the producer graphics engine 404 and the consumer graphics engine 406 will be less than the amount of memory necessary for a full frame of data. Once the producer graphics engine 404 completes its operation of loading a sub-frame of data 510 into memory 408, the producer graphics engine 404 will trigger the consumer graphics engine 406 to begin processing the sub-frame of data 510 stored by the producer graphics engine 404. As discussed above, synchronization points may also be used, but rather than using a frame boundary (waiting for a full frame of data to be prepared or processed before reaching the sync point), a sync point may be set for a sub-frame boundary (e.g., a specified line resolution and/or a macro-block).

In one exemplary embodiment, a consumer graphics engine 406 does not need to wait for a complete frame of data to be prepared by the producer graphics engine 404 before it can start processing the data. Hence startup latency may be reduced. Because only a portion of a frame of data 510 is stored in memory 408, an allocated memory footprint will also be lower. Furthermore, the use of only a sub-frame of data 510 may increase spatial and temporal locality in the memory 408 which may yield better memory 408 performance. Lastly, using a sub-frame boundary for a synchronization point between multiple graphics engines 404, 406 may provide a better utilization of system resources.

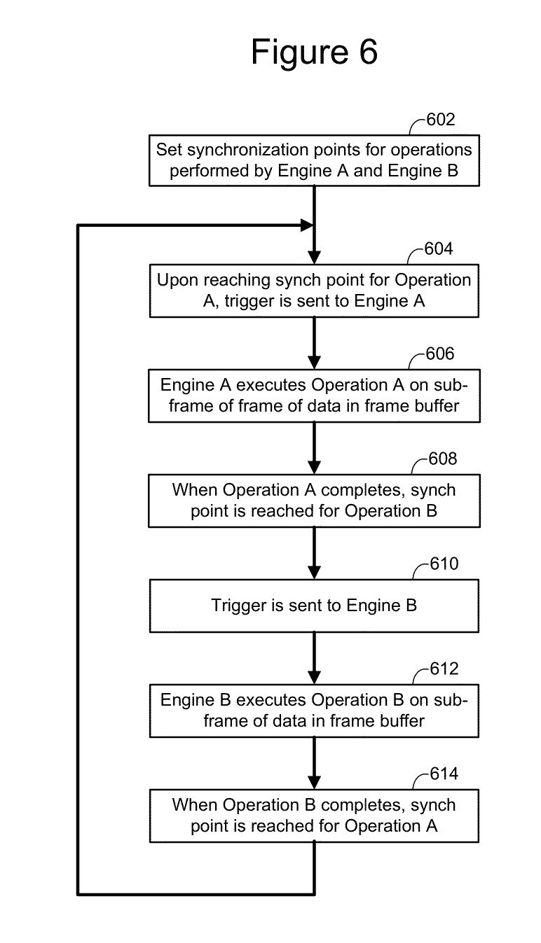

FIG. 6 illustrates steps to a process for synchronizing the operation of graphics engines sharing a memory location. In step 602 of FIG. 6, synchronization points are set for operations performed by a graphics engine A and a graphics engine B. A first synchronization point may be set for allowing graphics engine A to access a memory 408 after graphics engine B has completed its operations on data stored in the shared memory 408. A second synchronization point may be set for allowing graphics engine B to access the memory 408 after graphics engine A has completed its operations on the data stored in the shared memory 408.

In step 604 of FIG. 6, upon reaching the selected synchronization value for an operation A performed by graphics engine A, a trigger may be sent to graphics engine A. Until this trigger was received, graphics engine A would have been paused or idled in performing operation A. In step 606 of FIG. 6, graphics engine A receives the trigger and executes operation A on a sub-frame of data (less than a whole frame of data) stored in memory 224. In one exemplary embodiment, graphics engine A is a producer graphics engine 404 and is producing and storing a sub-frame of data into the allocated portion of memory 224.

In step 608 of FIG. 6, when operation A completes, a synchronization point value for operation B is reached. In step 610 of FIG. 6, upon reaching the selected synchronization value for operation B performed by graphics engine B, a trigger may be sent to graphics engine B. Until this trigger was received, graphics engine B would have been paused or idled in performing operation B. In step 612 of FIG. 6, graphics engine B receives the trigger and executes operation B on the sub-frame of data (less than a whole frame of data) stored in memory 224. In one exemplary embodiment, graphics engine B is a consumer graphics engine 406 and may consume the previously stored sub-frame of data in the allocated portion of memory 224 and produce a finished sub-frame of data for output from the memory 224. In step 614 of FIG. 6, when operation B completes, a synchronization point value for operation A is reached.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A method for synchronizing a plurality of pixel processing units, the method comprising:
sending a first trigger to a first pixel processing unit to execute a first operation on a portion of a frame of data; and
sending a second trigger to a second pixel processing unit to execute a second operation on the portion of the frame of data when the first operation has completed, wherein the first operation has completed when the first operation reaches a sub-frame boundary.

2. The method of claim 1 further comprising:
setting synchronization points for performing the first operation and the second operation, wherein the first operation and the second operation are executed when their respective synchronization points are reached.

3. The method of claim 2, wherein a synchronization point for the first operation is reached when the second operation is complete; and wherein a synchronization point for the second operation is reached when the first operation is complete.

4. The method of claim 2, wherein the setting synchronization points comprises setting a numerical value for each of the first and second operations, and further comprising completing the first and second operations, wherein the completing the first and second operations comprises one or more incrementations of a synchronization point counter for each of the first and second operations, and wherein the value of the synchronization point counters equals the set numerical values.

5. The method of claim 1, wherein the first operation comprises preparing and placing the portion of the frame of data into a frame buffer, and wherein the second operation comprises processing the portion of the frame of data and preparing a finished portion of a frame of data.

6. The method of claim 1, wherein a portion of a frame of data comprises one of:
one or more macro-blocks; and
a defined resolution line of a frame of data.

7. The method of claim 1 further comprising sending the first trigger to the first pixel processing unit to execute the first operation on a portion of a new frame of data when the second operation has completed.

8. The method of claim 1, wherein the portion of the frame of data is stored in a frame buffer, wherein only enough memory to hold the portion of the frame of data is allocated to the first pixel processing unit and the second pixel processing unit.

9. A graphics processor comprising:
means for sending a first trigger to a first pixel processing unit to execute a first operation on a portion of a frame of data; and
means for sending a second trigger to a second pixel processing unit to execute a second operation on the portion of the frame of data when the first operation has completed, wherein the first operation has completed when the first operation reaches a sub-frame boundary.

10. The graphics processor of claim 9 further comprising:
means for setting synchronization points for performing the first operation and the second operation, wherein the first operation and the second operation are executed when their respective synchronization points are reached.

11. The graphics processor of claim 10, wherein a synchronization point for the first operation is reached when the second operation is complete, and wherein a synchronization point for the second operation is reached when the first operation is complete.

12. The graphics processor of claim 10, wherein the means for setting synchronization points comprises means for setting a numerical value for each of the first and second operations, wherein completing the first and second operations comprises one or more incrementations of a synchronization point counter for each of the first and second operations, and wherein the value of the synchronization point counters equals the set numerical values.

13. The graphics processor of claim 9, wherein the first operation comprises preparing and placing the portion of the frame of data into a frame buffer, and wherein the second operation comprises processing the portion of the frame of data and preparing a finished portion of a frame of data.

14. The graphics processor of claim 9, wherein a portion of a frame of data comprises one of:
one or more macro-blocks; and
a defined resolution line of a frame of data.

15. The graphics processor of claim 9 further comprising:
means for sending the first trigger to the first pixel processing unit to execute the first operation on a portion of a new frame of data when the second operation has completed.

16. The graphics processor of claim 9, wherein the portion of the frame of data is stored in a frame buffer, and wherein only enough memory to hold the portion of the frame of data is allocated to the first pixel processing unit and the second pixel processing unit.

17. A graphics processor comprising:
a plurality of pixel processing units, each operable to perform an operation on a portion of a frame of data, wherein the plurality of pixel processing units comprise a first and a second pixel processing unit;
a synchronization module coupled to the plurality of pixel processing units and operable to synchronize the plurality of pixel processing units, wherein the synchronization module is further operable to send a first trigger to the first pixel processing unit to execute a first operation on the portion of the frame of data, and to send a second trigger to the second pixel processing unit to execute a second operation on the portion of the frame of data when the first operation has completed, wherein the first operation has completed when the first operation reaches a sub-frame boundary.

18. The graphics processor of claim 17, wherein the synchronization module is further operable to set synchronization points for performing the first operation and the second operation, and wherein the first operation and the second operation are executed when their respective synchronization points are reached.

19. The graphics processor of claim 17, wherein a synchronization point for the first operation is reached when the second operation is complete; and wherein a synchronization point for the second operation is reached when the first operation is complete.

20. The graphics processor of claim 18, wherein the synchronization module comprises:
a plurality of synchronization point registers, wherein each synchronization point register is operable to increment when specified events are accomplished, and wherein the synchronization points are reached when the sync point registers have incremented to values equal to respective synchronization point values.

21. The graphics processor of claim 17, wherein the first operation comprises preparing and placing the portion of the frame of data into a frame buffer, and wherein the second operation comprises processing the portion of the frame of data and preparing a finished portion of a frame of data.

22. The graphics processor of claim 17, wherein a portion of a frame of data comprises one of:
one or more macro-blocks; and
a defined resolution line of a frame of data.

23. The graphics processor of claim 17 further comprising a memory module, wherein the portion of the frame of data is stored in a frame buffer in the memory module, wherein only enough memory to hold the portion of the frame of data is allocated in the memory module.
